(19) United States
(12) Patent Application Publication
(10) Pub. No.: US 2006/0155983 A1
(43) Pub. Date: Jul. 13, 2006

(54) Method of local data distribution preserving rights of a remote party

(76) Inventor: Jonathan L. Rowlands, Somerville, MA (US)

Correspondence Address: TEXAS INSTRUMENTS INCORPORATED, P O BOX 655474, M/S 3999, DALLAS, TX, 75265, US

(21) Appl. No.: 11/305,512

(22) Filed: Dec. 16, 2005

Related U.S. Application Data
(62) Division of application No. 09/998,234, filed on Dec. 3, 2001.
(60) Provisional application No. 60/256,978, filed on Dec. 21, 2000.

(51) Int. Cl. H04L 9/00

(52) U.S. Cl. 713/155

(57) ABSTRACT

A method and system of data distribution of musical data preserving the rights of a remote party employing cryptographic keys both a public key and a private key whereby a recipient must know a secret key in order to read some protected data. The sender must know a key to send the data which key being a shared secret of the sender and receiver in the private key case. This private key cryptography enables a secure two-way dialog between certain parties, while public key cryptography enables secure one way communication from anyone to a certain recipient.

This application is a divisional application of U.S. patent application Ser. No. 09/998,234 filed Dec. 3, 2001.

### FIELD OF INVENTION

This invention relates to distribution of digital data such as digital music and in particular to distribution while preserving copyright rights.

### BACKGROUND OF THE INVENTION

The widespread use of the Internet to distribute digital music is a new phenomenon, and much of the technological infrastructure that will persuade consumers to embrace Internet music does not yet exist. The invention concerns one novel piece of this infrastructure:—a method of electronically transferring digital music between items of consumer end equipment such as portable players, CD players, computers, and jukeboxes, which preserves the rights and interests of stakeholders.

Piracy, or copying and using musical data against the wishes of the copyright holders, is considered a serious problem for Internet music. The music industry is almost universally adopting techniques to prevent copying of digital music between consumers. The aim of these techniques is to protect the rights and interests of copyright holders by requiring consumers to obtain their musical data from authorized agents, so that licensing and payment can be enforced.

When the rights of producers are not a consideration, consumers do not obtain all of their music directly from authorized agents. Cassette tapes and music CDs are copied for personal use or for friends, music is recorded from the radio, and unprotected music files on hard disk are exchanged between friends. These are transactions between peers, which are specifically prevented by the anti-piracy techniques endorsed by the music industry at this time. The aim of the invention is to modify the anti-piracy techniques to permit such transactions between peer consumers or consumer equipment, while respecting the rights and interests of the copyright holders.

### SUMMARY OF THE INVENTION

The invention makes a deliberate distinction between the act of copying the musical data and the transaction of authorizing its use, and allows the two to be conducted separately and by different parties. This mirrors traditional retail commerce using a credit card, where physical goods are exchanged by local transactions, but authorized by small transactions with a remote authority. This is advantageous because of the different characteristics of the two types of exchange.

In accordance with one embodiment of the present invention an authorized user (the sender) transmits the data to a new user (the receiver). The invention has the novel aspect that no trusted agent is required to mediate the data transfer. A trusted agent is ultimately required to authorize the receiver's use of the data. This negotiation may occur before or after the transfer of data, and need not involve the sender.

### DESCRIPTION OF DRAWINGS

In the drawing:

FIG. 1 illustrates one embodiment of the present invention; and

FIG. 2 illustrates a second embodiment of the present invention.

### DESCRIPTION OF PREFERRED EMBODIMENTS

Copying involves the transfer of large amounts of musical data, making a high-bandwidth data connection desirable. These are inexpensive and common between items of consumer end equipment, but high-speed connections to the Internet are significantly more expensive and rare at this time. This favors highly local communication for the distribution of the musical data. For example, Alice could connect her portable music player directly to Bob's jukebox to obtain certain music, and this might be more convenient than for Alice to download it from the Internet herself.

Authorization for use requires communication with a trusted authorizing agent, so inherently requires non-local communication. However it can properly be verified using only small data transfers. Thus authorization may conveniently be transacted using commonly available low-speed wide-area networks, such as the traditional wired or cellular telephone networks.

The invention enables local secure distribution by permitting any authorized user of musical data to replicate the data for distribution. Three types of parties are recognized:—unauthorized users, authorized users, and trusted agents. According to the invention an authorized user (the sender) transmits the data to a new user (the receiver). The invention has the novel aspect that no trusted agent is required to mediate the data transfer. A trusted agent is ultimately required to authorize the receiver's use of the data, however this negotiation may occur before or after the transfer of data, and need not involve the sender. Many different sources might be available for local distribution of the encrypted musical data, including but not limited to a friend's jukebox, a radio broadcast, a mall kiosk, or a local area network server.

It should be emphasized that the consumer equipment embodies rules that, to a certain extent, go against the wishes of the person who owns it, for example in preventing unrestricted copying. In the discussion that follows, it is assumed that an attacker has not compromised the equipment's function. Techniques to prevent and detect tampering or imposture are required in any secure system, and will not be discussed further. It is also assumed that any communications may be intercepted, and should be protected by encryption. Methods of doing this are also well known and will not be discussed.

The invention enables local secure distribution by permitting any authorized user of musical data to replicate the data for distribution. Three types of parties are recognized:—unauthorized users, authorized users, and trusted agents. According to the invention an authorized user (the sender) transmits the data to a new user (the receiver). The invention has the novel aspect that no trusted agent is required to mediate the data transfer. A trusted agent is ultimately required to authorize the receiver's use of the data, however this negotiation may occur before or after the transfer of data, and need not involve the sender. Many different sources might be available for local distribution of the encrypted musical data, including but not limited to a friend's jukebox, a radio broadcast, a mail kiosk, or a local area network server.

Several possible instantiations of the invention are described here.

1. Peer Distribution with Centralized Post-Authorization

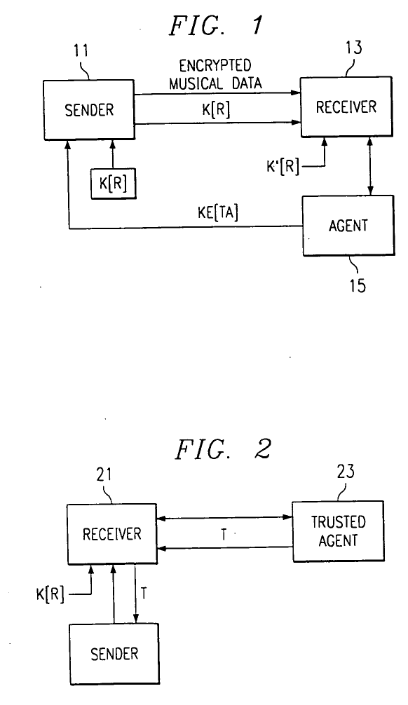

In this scenario, an authorized user of the data (the sender) 11 transmits the data to an unauthorized user (the receiver) 13. See FIG. 1. The receiver 13 must contact a trusted authorizing agent before the full utility of the data is made available to him.

The following steps are required to transfer the data from the sender to the receiver:

Step 1 the sender 11 chooses an encryption key K[R] for the receiver's use;

Step 2 the sender 11 encrypts the musical data using K[R];

Step 3 the sender 11 encrypts K[R] using KE[TA], the public encryption key of a trusted agent; and

Step 4 the sender 11 transmits both the encrypted data and the encrypted key K[R] to the receiver 13.

The following steps are then required to authorize the receiver to use the data:

Step 5 the receiver 13 and the trusted agent 15 negotiate licensing and payment for the musical data;

Step 6 the receiver 13 transmits the encrypted key K[R] to the trusted agent 15;

Step 7 the trusted agent 15 decrypts K[R] and sends it back to the receiver 13; and

Step 8 the receiver 13 optionally chooses a new key K′[R] unknown to the sender 11 and re-encrypts the musical data

This scenario might be realized in one way as follows. Alice gives Bob copies of music that he might like, by connecting his portable music player to her music collection. However even though Bob now possesses the musical data he is unable to listen to it until he has paid for it, or can listen to it only with reduced audio quality. Using his cellular telephone his portable-player contacts a trusted agent to arranges payment, at which time he has full access to the music.

2. Peer Distribution with Centralized Pre-Authorization

In this scenario, the receiver 21 negotiates with a trusted agent 23 to obtain a ticket T that represent the musical data. See FIG. 2. The ticket T is a small piece of data that the receiver 21 uses to prove to the sender 25 that they have obtained authorization. The ticket T is embedded in the encrypted musical data and is known to every authorized user of the data, to the same extent that the data itself is known. The receiver 21 presents the ticket to the sender 25 for inspection, after which the sender 25 may provide the receiver 21 with the unencrypted data. The receiver 21 then re-encrypts the data for storage using a new key.

The following steps are required to authorized the receiver 21 to use the data:

Step 1 The receiver 21 negotiates licensing and payment with a trusted agent 23; and

Step 2 The trusted agent 23 transmits a ticket T to the receiver 21.

The following steps are then required to transfer the data from the sender 25 to the receiver 21:

Step 1 The sender 25 interrogates the receiver 21 to determine whether the ticket T is valid, and halts if not;

Step 2 The sender 25 transmits the unencrypted musical data to the receiver 21; and

Step 3 The receiver 21 chooses a key K[R] and encrypts the musical data

This scenario might be realized in the following way. Bob joins a musical subscription service, which emails him each month tickets for 50 new songs. The tickets authorize him to obtain those songs by any means that present itself, whether by downloading them using his computer, or by copying them from a friend or a kiosk in a mall.

Best Mode of Participating the Invention

Special considerations are commonly taken to reduce the consequences of a breach in the system security. In particular, care should be taken to minimize the number of parties who know a shared secret. This reduces the possibility of the secret being disclosed in addition to limiting the damage should that occur. In the invention this should be taken into account in choosing the encryption keys and the ticket.

In the absence of a security breach, it would be practical for the receiver's copy of the musical data to use the same encryption key as the sender's own copy. However, this would propagate many copies of the same encrypted data. Should the key become publicly known, these copies would be easily available to unauthorized users. So it is preferable for each user to re-encrypt the musical data using a new key each time it changes hands. If a key becomes publicly known the problem could be more easily contained.

In the pre-authorization scenario the ticket is valuable. An attacker may attempt to obtain the ticket from a receiver by masquerading as a sender in the transaction. To maintain secrecy of the ticket it may be inspected using a zero-knowledge proof, whereby during the inspection neither sender nor receiver can discover anything about the ticket that they don't already know. Zero-knowledge proofs are well known to practitioners in the art.

Further, a different ticket should be used for each receiver, to limit he consequences should a ticket be disclosed. The ticket should depend on a unique identifying value stored in hardware in the receiver's equipment, so that the ticket from another receiver's transaction will not work. Such identifying values exist in current equipment for similar purposes.

Problems Solved by the Invention

Copy restrictions placed on digital music may represent a barrier to the development of the Internet audio market, since consumers resist technologies that revoke freedoms that they previously enjoyed. Accordingly, the amount of freedom granted to the consumer will be a factor in selecting between the various digital rights management solutions competing in the marketplace. The invention promotes a relatively non-intrusive distribution model whereby musical data may be exchanged securely between peer consumers without the immediate oversight of a trusted agent. This can significantly enhance ease of use since it permits distribution methods and bypasses the wide-area communications bandwidth bottleneck.

Fully centralized distribution of musical data does not support a large marketplace efficiently. The required infrastructure is wasteful, since all transactions are required to be non-local. It is slow to adapt to changes in demand, since remote bodies must act to enable local supply. It is slow to incorporate technological innovations, since changes carry high risk. The invention supports a distributed musical data distribution system, whereby members of a community may adapt the local infrastructure to support their local requirements for high-bandwidth data transfer within the community.

1-4. (canceled)

5. A method of data distribution preserving rights of a remote party comprising the steps of:
a receiver negotiating licensing and payment with a trusted agent;
the trusted agent transmitting a ticket to a receiver;
a sender interrogating the receiver to determine if the ticket is valid and halts if not;
if the ticket is valid, the sender locally transmitting the un-encrypted data to the receiver.

6. The method of claim 5 including the step of:
the receiver chooses a key and encrypts the data.

7. The method of claim 5, wherein:
said steps of the sender interrogating the receiver and the sender transmitting un-encrypted data to the receiver both include directly connecting an apparatus of the sender to an apparatus of the receiver.

8. The method of claim 5, wherein:
said steps of the sender interrogating the receiver and the sender transmitting un-encrypted data to the receiver both include employing a local connection having a first bandwidth; and
said steps of the receiver negotiating licensing and payment with the trusted agent and the trusted agent transmitting a ticket to the receiver both include employing a network having a second bandwidth less than said first bandwidth.

9. The method of claim 5, wherein:
said steps of the receiver negotiating licensing and payment with the trusted agent and the trusted agent transmitting a ticket to the receiver occur simultaneously for a plurality of tickets; and
said steps of the sender interrogating the receiver and the sender locally transmitting the un-encrypted data to the receiver occur for a single ticket and corresponding data at a time.
